(19) United States
(12) Patent Application Publication
(10) Pub. No.: US 2005/0132145 A1
(43) Pub. Date: Jun. 16, 2005

(54) Contingent processor time division multiple access of memory in a multi-processor system to allow supplemental memory consumer access

(75) Inventors: Gerald L. Dybsetter, Scotts Valley, CA (US); Jayne C. Hahin, Cupertino, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 10/814,392

(22) Filed: Mar. 31, 2004

Related U.S. Application Data
(60) Provisional application No. 60/530,037, filed on Dec. 15, 2003.

(51) Int. Cl. G06F 12/00

(52) U.S. Cl. 711/150; 711/153

(57) ABSTRACT

Mechanisms in which a memory controller efficiently manages time-division multiple access to system memory for multiple processors and for one or more other memory consumers present in the system. At least one processor is guaranteed access to system memory during its time slot in a memory access cycle, while at least one of the other processors is only conditionally granted access to system memory during its time of the memory access cycle. In particular, these other processors are only granted access if one of more certain other memory consumers has not also requested memory access at the same time. Accordingly, urgent, time-sensitive processes may run on these guaranteed processors, while allowing less time-sensitive processes to run on the other processors. Hence, access to system memory is managed more efficiently.

### CROSS-REFERENCE TO RELATED APPLICATIONS

This application claims the benefit of U.S. Provisional Application No. 60/530,037 filed Dec. 15, 2003, which is incorporated herein by reference in its entirety.

### BACKGROUND OF THE INVENTION

1. The Field of the Invention

The present invention relates generally to mechanisms for accessing system memory. More particularly, the present invention relates to controlling memory access using time division multiplexing.

2. Background and Relevant Art

Electronic and computing technology has transformed the way that we work and play. Many electronic or computing systems rely on system memory to retain information important for the proper operation of the system. As systems are becoming more complex, multiple components in the system may need access to the system memory. For example, in multi-processor systems, each processor needs to access system memory. Furthermore, one or more other non-processor components may also access system memory.

As many components need access to system memory, it is important that orderly access to system memory be maintained so that all components have the required access. Accordingly, a memory controller often governs access to system memory. The memory controller typically imposes time division multiple access on the system memory. In other words, one processor is granted access to system memory during a first time, another processor during another time, and so forth, for all memory consuming components in the system.

This conventional time division multiple access mechanism is advantageous in that each component may take their turn accessing system memory. Accordingly, while access may not be immediate, each will have their turn, and will be guaranteed (absent some system failure) to have access during its turn. However, even if components need access to system memory, the volume of information communicated to and from system memory for that component may be quite low. For example, components that use serial interfaces typically only communicate one bit at a time. Accordingly, much of the time slot allotted to that component may be wasted. Meanwhile, the time that other processors and components must wait is rather long due to the length of the time slot for the low volume memory consuming component.

Although the time slot for the low volume memory consuming component may be shortened, there are limits imposed by the system clock on how short the time slot may be. Furthermore, the volume of information communicated to and from memory may still be so low that bandwidth is wasted.

Accordingly, what is desired are memory control mechanisms in which access by multiple processors and components is more efficiently managed to make more productive use of bandwidth with system memory.

### BRIEF SUMMARY OF THE INVENTION

The foregoing problems with the prior state of the art are overcome by the principles of the present invention, which are directed towards mechanisms in which a memory controller efficiently manages access to system memory for multiple processors and for one or more other memory consumers present in the system.

The memory controller operates using a variant of time division multiplexing. In particular, at least one of the processors is guaranteed access to system memory during its time, while at least one of the other processors is only conditionally granted access to system memory during its time. In particular, these other processors are only granted access if one of more certain other memory consumers has not also requested memory access at the same time.

These other memory consumers have fewer memory demands than a processor. Thus, the fraction of time that the other processors' access to system memory will be interrupted can be quite small. This is particular true of the other memory consumers use a serial interface. Accordingly, even with this conditional access to memory, the processors will typically have all the memory access that it needs, even if one of its turns is taken by the other memory consuming component. Meanwhile, one or more of the processors is guaranteed access to system memory during its turn. Accordingly, urgent, time-sensitive processes may run on these guaranteed processors, while allowing less time-sensitive processes to run on the other processors. Hence, access to system memory is managed more efficiently.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a system in which a memory controller manages access to system memory from processors and other memory consuming components;

FIG. 2 illustrates a memory access cycle that may be time division multiplexed as enforced by the memory controller;

FIG. 3 illustrates a flowchart of a method for setting up the memory controller to manage access to system memory in accordance with the principles of the present invention;

FIG. 4 illustrates a flowchart of a method for managing access during a time slot in the memory access cycle in which a guaranteed processors requests access to system memory in accordance with the principles of the present invention;

FIG. 5 illustrates a flowchart of a method for managing access during a time slot in the memory access cycle in which a conditioned processor may conditionally access system memory subject to opposing requests from other memory consumers in accordance with the principles of the present invention;

FIG. 6 illustrates a schematic diagram of a laser transmitter/receiver that represents one of many systems in which the principles of the present invention may be employed; and

FIG. 7 illustrates a digital portion of the control chip illustrated in FIG. 6, the digital portion including a memory that multiple processors and other memory consuming components access through a memory controller.

### DETAILED DESCRIPTION OF THE PREFERRED EMBODIMENTS

The principles of the present invention provide for mechanisms in which a memory controller efficiently manages time-division multiple access to system memory for multiple processors and for one or more other memory consumers present in the system. At least one processor is guaranteed access to system memory during its time, while at least one of the other processors is only conditionally granted access to system memory during its time. In particular, these other processors are only granted access if one of more certain other memory consumers has not also requested memory access at the same time. Accordingly, urgent, time-sensitive processes may run on these guaranteed processors, while allowing less time-sensitive processes to run on the other processors. Hence, access to system memory is managed more efficiently.

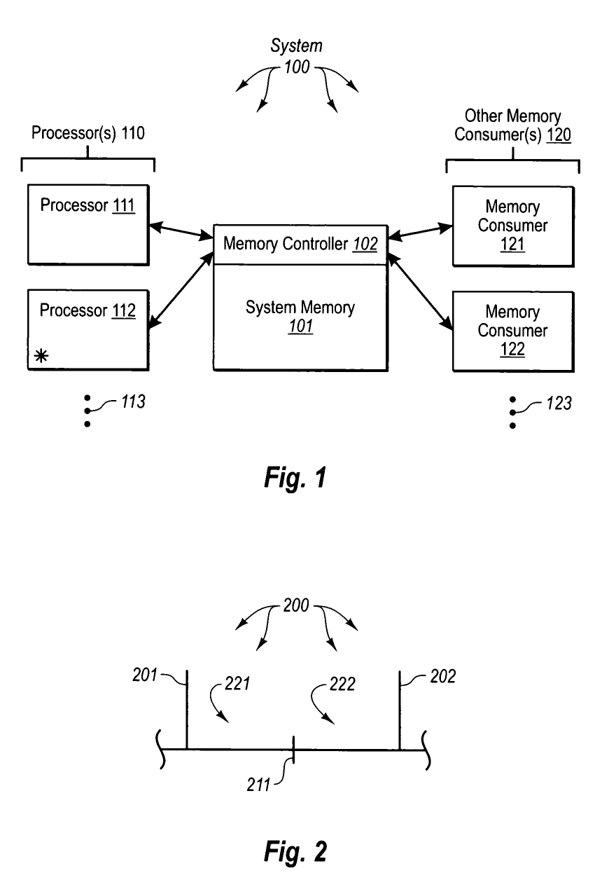

Turning to the drawings, FIG. 1 illustrates a suitable electronic or computing system 100 in which the principles of the present invention may be employed. The system 100 includes a system memory 101, a memory controller 102, a plurality of processors 110, and one or more other memory consuming modules 120. The plurality of processors 110 include processor 111, processor 112, amongst potentially one or more other processors as represented by the vertical ellipses 113. The one or more other memory consuming components 120 includes at least memory consuming component 121. The one of more other memory consuming components may potentially include multiple memory consuming components, in which case memory consuming component 122 may be included amongst potentially others as represented by the vertical ellipses 123.

Each of the processors 110 and the other memory component(s) 120 access system memory 101 through the memory controller 102. In order to avoid conflicts, the memory controller 102 operates by time division multiple access to the system memory 101. In other words, the memory controller 102 has an access cycle that it divides into multiple time slots (or divisions). The memory access rules imposed by the memory controller 102 differ depending on the current time slot.

FIG. 2 illustrates a diagram of a memory access cycle 200. The memory access cycle includes a beginning time 201 and an ending time 202. The memory access cycle may be divided in any way possible. However, in the illustrated embodiment, the memory access cycle is illustrated as having two time slots; namely, time slot 221 (beginning at time 201 and ending at time 211), and time slot 222 (beginning at time 211 and ending at time 202). So long as the memory controller 102 is able to distinguish one time slot from the next, there is no limit to how the memory access cycle may be divided. Combinations of one or more time slots (whether contiguous in time or not) may be perceived as being a single time slot or division within the scope of the present invention. Although two time slots are shown, a memory access cycle may include three or more time slots as is known to those of ordinary skill in the art.

System memory 101 may be volatile (such a Random Access Memory (RAM)), or may be non-volatile (such as Read Only Memory (ROM), Flash memory, or the like), or a combination or volatile or non-volatile memory. However, the system memory 101 may be any memory capable of being accessed by processors 110 and other memory consuming components 120 via the memory controller 102. Such processor-readable media may include, but is not limited to, RAM, ROM, EEPROM, flash memory, memory sticks, other memory technology, CD-ROM, digital versatile disks, other optical storage, magnetic cassettes, magnetic tape, magnetic disk storage, other magnetic storage devices, and any other media that can be used to store the desired information.

Optionally, there may be other modules within the system 100. Whether or not there are other modules, and the nature of the modules, will depend on the nature of the system 100. The system 100 may be any electronic or computing system including, but not limited to any general-purpose or special-purpose computing or communications environments or configurations. Examples of well known computing systems, environments, and configurations include, but are not limited to, laser transmitter/receivers, mobile telephones, pocket computers, personal computers, servers, multiprocessor systems, microprocessor-based systems, minicomputers, mainframe computers, and distributed computing environments that include any of the above systems or devices. Any of these example systems are suitable for use with the principles of the present invention

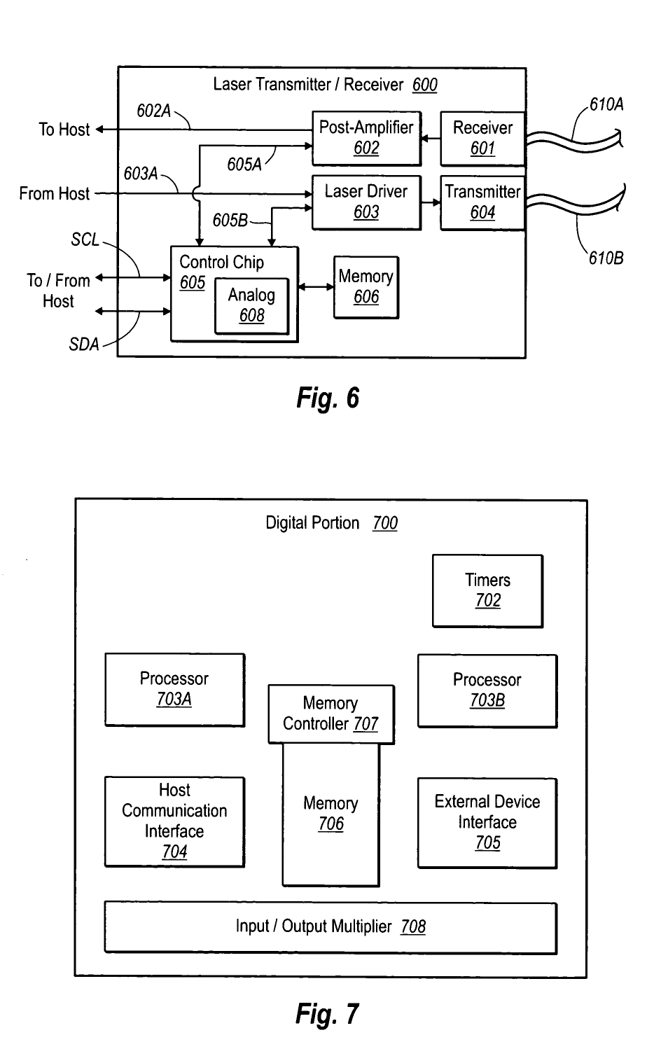

If the system 100 was a general-purpose computing system, the other modules may include, for example, video adaptor modules, network interface modules, hard disk drive interfaces, optical disk drive interfaces, magnetic disk drive interfaces, or the like. If the system 100 was a laser transmitter/receiver, the other modules may include laser drivers, analog-to-digital converters, digital-to-analog converters, serial interface controllers, or the like. FIG. 6 illustrates a specific embodiment of a laser transmitter/receiver 600, which will be described in further detail below with respect to FIGS. 6 and 7. However, those of ordinary skill in the art will recognize after having read this disclosure, that the principles of the present invention are not limited to application in a general-purpose computing system, or a laser transmitter/receiver, notwithstanding the detailed description of the laser transmitter/receiver which follows further below.

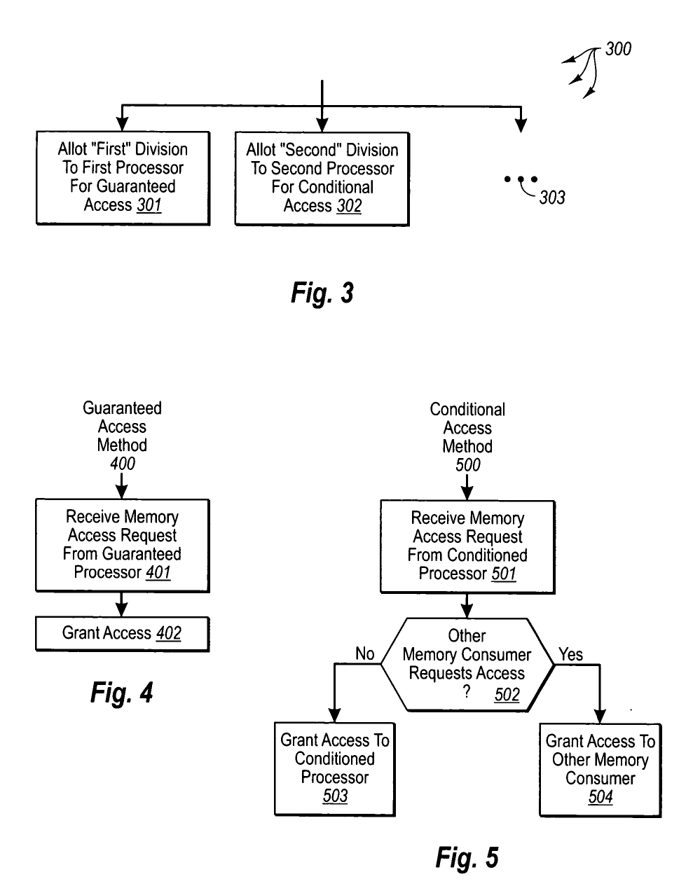

FIG. 3 illustrates a flowchart of a method 300 for setting up the memory controller to manage access to system memory in accordance with the principles of the present invention. In particular, the memory controller allots a first division of each of memory access cycle (e.g., time slot 221 of FIG. 2) to time-division multiple access of the system memory for a first processor of the plurality of processors (act 301). In this description and in the claims, the terms “first”, “second”, “third”, “fourth”, and so forth will be used to merely distinguish one item from another item, not to imply any sort of sequential ordering. The memory controller guarantees access for this first processor during the first division of each of plurality of memory access cycles. A processor that has guaranteed access during its time division in the memory access cycle will also be referred to herein as a “guaranteed processor”.

The memory controller also allots a second division (e.g., time slot 222 of FIG. 2) of each of the memory access cycles to time-division multiple access of the system memory for a second processor of the plurality of processors (act 302). The memory controller 102 only conditionally grants memory access to the second processor during the second division subject to a determination that at least one of the one or more other memory consumers has not also requested access to the system memory. A processor that has such conditional access during its time division in the memory access cycle will also be referred to herein as a “conditioned processor”. In FIG. 1, processor 111 is a guaranteed processor. Processor 112 is a conditioned processor as represented by the lower left-hand corner of the processor 112 including an asterix.

During operation, the memory access rules imposed by the memory controller 102 vary depending on whether it is the first division of the memory access cycle in which the guaranteed processor 111 is guaranteed access to system memory 101, or whether it is the second division of the memory access cycle in which the conditioned processor 122 is granted conditional access to system memory 101.

FIG. 4 illustrates flowchart 400 of a mode of operation when the memory controller 102 is operating in a time slot in which it is a guaranteed processor's turn to access system memory 101. In other words, the current time division in the memory access cycle belongs to a guaranteed processor (e.g., guaranteed processor 111 or a guaranteed processor from one of the additional processors 113, if any). Simply put, in response to a request to access the system memory from the guaranteed processor (act 401), the requested access is granted (act 402), regardless of whether or not other memory consumers also request access during the same time division.

FIG. 5 illustrates a flowchart 500 of a mode of operation when the memory controller 102 is operating in a time slot in which it is a conditioned processor's turn to access system memory 101. In other words, the current time division in the memory access cycle belongs to a conditioned processor (e.g., conditioned processor 112 or a conditioned processor from one of the additional processors 113, if any). Here the flow of operation differs depending on whether or not other memory consuming components have requested access to the system memory 101 during the conditioned processor's turn.

If another memory consuming component has not requested access to the system memory 101 during the conditioned processor's turn, the memory controller 102 receives a request to access the system memory during the turn of the conditioned processor from the conditioned processor (act 211). It is then determined that at least one of the other memory consuming components has not requested to access system memory (No in decision block 212).

In some cases, the conditioned processor will be configured to abstain from sending a request to access system memory if it receives an indication that another memory consuming component has already made such a request. In other cases, the system 100 may be configured such that the memory controller 102 never receives any memory access request from the conditioned processor if another memory consuming component has also generated a request for memory access during that same time division. In either case, the determination that other memory consuming components did not make a request to access memory (NO in decision block 502) may be inferred by the very fact that the memory controller 102 did, in fact, receive a memory access request from the conditioned processor.

After the memory controller 102 receives the memory access request from the condition processor (act 501), and determines that no other memory consuming component has requested access (NO in decision block 502), the conditioned processor is granted the requested access (act 503). In other words, the requested memory access is imposed upon the system memory 101.

Alternatively, a memory consuming component may have requested access during the conditioned processor's turn. In that case, the conditioned processor may optionally request memory access (act 501). However, as previously mentioned, the conditioned process may be configured to refrain from generating such a request (or the system may be configured to refrain from delivering such a request to the memory controller of another memory consuming component has requested memory access during that same time division.

The memory controller 102 then determines that another memory consuming component has requested memory access (YES in decision block 502), and then allows the other requesting memory consuming component to have the requested access to the system memory during the second division of the second memory access cycle (act 504).

Accordingly, there is always at least one guaranteed processor upon which time sensitive processes may be executed. In addition, if the other memory consuming components 120 are low volume memory consumers (e.g., having serial interfaces), it may be less frequent that memory access for even the conditioned processor is preempted. In one embodiment in which two other memory consuming components having a serial interface with the conditioned processor, the two other memory consuming components may have such a low volume of memory exchange (even at maximum memory consuming capacity), that the conditioned processor has access to the system memory during its turn no less than seventy-five percent of the its turns.

Accordingly, memory access is shared between multiple processors and one or more other memory consuming components while guaranteeing access during the guaranteed processor's turn to access memory, and with very little imposition on the conditioned processor's turn to access memory. Furthermore, the other memory consuming components did not need their own dedicated time division in the memory access cycle. Accordingly, the memory access cycle remains short, thereby allowing each component frequent access to system memory.

FIG. 6 illustrates a laser transmitter/receiver 600 in which the principles of the present invention may be employed. While the laser transmitter/receiver 600 will be described in some detail, the laser transmitter/receiver 600 is described by way of illustration only, and not by way of restricting the scope of the invention. As the principles of the present invention allow for more efficient access to system memory, processing efficiency and speed are improved. This will become increasingly important for faster bit rates transfers. Accordingly, the principles of the present invention are suitable for 1 G, 2 G, 4 G, 10 G and higher bandwidth fiber channels. Furthermore, the principles of the present invention may be implemented in laser transmitter/receivers of any form factor such as XFP, SFP and SFF, without restriction. Having said this, the principles of the present invention are not limited to a laser transceiver environment at all.

The laser transmitter/receiver 600 receives an optical signal from fiber 610A using receiver 601. The receiver 601 transforms the optical signal to an electrical signal and provides that electrical signal to a post-amplifier 602. The post-amplifier 602 amplifies the signal and provides the amplified signal to the host as represented by arrow 602A.

The laser transmitter/receiver 600 may also receive electrical signals from the host for transmission onto the fiber 610B. Specifically, the laser driver 603 receives the electrical signal as represented by the arrow 603A, and drives the transmitter 604 (i.e., the laser) with signals that cause the transmitter 604 to emit onto the fiber 610B optical signals representative of the information in the electrical signal provided by the host.

The behavior of the receiver 601, the post-amplifier 602, the laser driver 603, and the transmitter 604 may vary dynamically due to a number of factors. For example, temperature changes, power fluctuations, and feedback conditions may each affect the performance of these components. Accordingly, the laser transmitter/receiver 600 includes a control chip 605, which evaluates temperature and voltage conditions, and receives information from the post-amplifier 602 (as represented by arrow 605A) and from the laser driver 603 (as represented by arrow 605B), which will allow the control chip 605 to counteract the dynamically varying performance, and detect when there is a loss of signal.

Specifically, the control chip 605 may counteract these changes by adjusting settings on the post-amplifier 602 and/or laser driver 603 as represented by the arrows 605A and 605B. The control chip 605 has access to a non-volatile memory 606, which in one embodiment, is an Electrically Erasable and Programmable Read Only Memory (EEPROM). Data and clock signals may be provided from the host to the control chip 605 using the serial clock line SCL, and the serial data line SDA. Also data may be provided from the control chip 605 to the host using serial data signal SDA to allow for digital diagnostics and readings of temperature levels, transmit/receiver power levels, and the like.

The control chip 605 includes both an analog portion 608 and a digital portion. Together, they allow the control chip to implement logic digitally, while still largely interfacing with the rest of the laser transmitter/receiver 600 using analog signals. For example, the analog portion 608 may contain digital to analog converters, and analog to digital converters, high speed comparators (e.g., for event detection), voltage based reset generators, voltage regulators, voltage references, clock generator, and other analog components.

FIG. 7 illustrates the digital portion 700 of control chip 605 in further detail. For instance, a timer module 702 provides various timing signals used by the digital portion. Such timing signals may include, for example, programmable processor times. The timer module 702 may also act as a watchdog timer that, for example, resets to a particular value when a processor generates a watchdog signal, and then counts down from the value until the next watchdog signal is detected when the value is once again reset to the particular value. Alternatively, if the watchdog timer decrements down to a minimum value, then the watchdog timer module 702 may take corrective action if the watchdog timer would not normally decrement to that value unless the processor had ceased or slowed execution of the microcode.

Two general-purpose processors 703A and 703B are also included, each configured to access a memory 706 through a memory control 707. In this sense, processor 703A may be one of the processors 111 or 112 illustrated and described above with respect to FIG. 1; processor 703B may be other of the processors 111 or 112 illustrated and described above with respect to FIG. 1; memory 706 may be the system memory 101 illustrated and described above with respect to FIG. 1; and memory control 707 may be the memory controller 102 illustrated and described above with respect to FIG. 1. However, the present invention is not so limited.

The processors 703 recognize instructions that follow a particular instruction set, and may perform normal general-purpose operation such as shifting, branching, adding, subtracting, multiplying, dividing, Boolean operations, comparison operations, and the like. In one embodiment, the general-purpose processors 703A and 703B are each a 16-bit processor and may be identically structured.

A host communications interface 704 is used to communicate with the host using the serial clock line SCL and the serial data line SDA of the laser transmitter/receiver 600. The external device interface 705 is used to communicate with, for example, other modules within the laser transmitter/receiver 600 such as, for example, the post-amplifier 602, the laser driver 603, or the memory 606.

The memory 706 may be Random Access Memory (RAM). The memory control 707 shares access to the memory 706 amongst each of the processors 703A and 703B and with the host communication interface 704 and the external device interface 705.

An input/output multiplexer 708 multiplexes the various input/output pins of the control chip 605 to the various components within the control chip 605. This enables different components to dynamically assign pins in accordance with the then-existing operational circumstances of the chip. Accordingly, there may be more input/output nodes within the control chip 605 than there are pins available on the control chip 605, thereby reducing the footprint of the control chip 605.

Having described a specific environment with respect to FIGS. 6 and 7 in which the principles of the present invention described with respect to FIGS. 1 through 5 may be employed, it will be understood that this specific environment is only one of countless architectures in which the principles of the present invention may be employed. As previously stated, the principles of the present invention are not intended to be limited to any particular environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

1. In a system that includes a system memory, and a plurality of processors and one or more other memory consumers that each access the system memory through a memory controller, a method for the memory controller to manage access to the system memory for each of the plurality of processors and the one or more other memory consumers, the method comprising the following:
an act of the memory controller allotting a first division of each of a plurality of memory access cycles to time-division multiple access of the system memory for a first processor of the plurality of processors such that memory access is guaranteed for the first processor during the first division of each of the plurality of memory access cycles; and
an act of the memory controller allotting a second division of each of the plurality of memory access cycles to time-division multiple access of the system memory for a second processor of the plurality of processors such that memory access is conditionally granted to the second processor during the second division of each of the plurality of memory access cycles subject to a determination that at least one of the one or more other memory consumers has not also requested access to the system memory.

2. A method in accordance with claim 1, wherein the first division in a given memory access cycle of the plurality of memory access cycles is before the second division in the given memory access cycle.

3. A method in accordance with claim 1, wherein the first division in a given memory access cycle of the plurality of memory access cycles is after the second division in the given memory access cycle.

4. A method in accordance with claim 1, wherein the first division in a given memory access cycle of the plurality of memory access cycles is adjacent in time with the second division in the given memory access cycle.

5. A method in accordance with claim 1, wherein the first division in a given memory access cycle of the plurality of memory access cycles is separated in time with the second division in the given memory access cycle by one or more other divisions.

6. A method in accordance with claim 1, further comprising the following:
an act of receiving a request to access the system memory from the second processor during the second division of the first memory access cycle of the plurality of memory access cycles;
an act of determining that at least one of the one or more other memory consumers has not also requested access to the system memory during the second division of the first memory access cycle; and
in response to the act of determining that at least one of the one or more other memory consumers has not also requested to access the system memory and the act of receiving the request from the second processor, an act of imposing the request from the second processor on the system memory.

7. A method in accordance with claim 6, wherein the act determining that at least one of the one or more other memory consumers has not also requested access to the system memory during the second division of the first memory access cycle comprises the following:
an act of concluding that the at least one of the one or more other memory consumers has not also requested access based on having received the request to access system memory from the second processor, wherein the request is not issued by the second processor if the at least one of the one or more memory consumers had requested access.

8. A method in accordance with claim 6, wherein the act determining that at least one of the one or more other memory consumers has not also requested access to the system memory during the second division of the first memory access cycle comprises the following:
an act of concluding that the at least one of the one or more other memory consumers has not also requested access based on having received the request to access system memory from the second processor, wherein the request from the second processor is not received by the memory controller if the at least one of the one or more memory consumers had requested access.

9. A method in accordance with claim 6, further comprising the following:
an act of determining that the at least one of the one or more other memory consumers has requested access to the system memory during the second division of a second memory access cycle of the plurality of memory access cycles; and
an act of allowing the at least one of the one or more other memory consumers to have access to the system memory during the second division of the second memory access cycle.

10. A method in accordance with claim 9, wherein the first memory access cycle is before the second memory access cycle.

11. A method in accordance with claim 9, wherein the first memory access cycle is after the second memory access cycle.

12. A method in accordance with claim 9, wherein the second memory access cycle is adjacent in time with the first memory access cycle.

13. A method in accordance with claim 9, wherein the second memory access cycle is separated in time with the first memory access cycle by one or more other memory access cycles.

14. A method in accordance with claim 9, further comprising the following:
an act of receiving a request from the second processor to access the system memory during the second division of the second memory access cycle, wherein the act of allowing the at least one of the one or more other memory consumers to have access to the system memory during the second division of the second memory access cycles is performed regardless of having received the request from the second processor to access the system memory during the second division of the second memory access cycle.

15. A method in accordance with claim 1, further comprising the following:
an act of the memory controller allotting a third division of each of a plurality of memory access cycles to time-division multiple access of the system memory for a third processor of the plurality of processors such that memory access is guaranteed for the third processor during the third division of each of the plurality of memory access cycles.

16. A method in accordance with claim 15, further comprising the following:
an act of the memory controller allotting a fourth division of each of the plurality of memory access cycles to time-division multiple access of the system memory for a fourth processor of the plurality of processors such that memory access is conditionally granted to the fourth processor during the fourth division of each of the plurality of memory access cycles subject to a determination that at least one of the one or more other memory consumers has not also requested access to the system memory.

17. A method in accordance with claim 1, further comprising the following:
an act of the memory controller allotting a fourth division of each of the plurality of memory access cycles to time-division multiple access of the system memory for a fourth processor of the plurality of processors such that memory access is conditionally granted to the fourth processor during the fourth division of each of the plurality of memory access cycles subject to a determination that at least one of the one or more other memory consumers has not also requested access to the system memory.

18. A method in accordance with claim 1, wherein at least one of the one or more other memory consumers includes a serial interface.

19. A method in accordance with claim 1, wherein the one or more memory consumers comprise a plurality of memory consumers.

20. A system comprising the following:
a system memory,
a memory controller that governs access to the system memory;
a plurality of processors that each access the system memory through the memory controller; and
one or more other memory consumers that also each access the system memory through the memory controller, wherein
the memory controller is configured to perform the following:
an act of allotting a first division of each of a plurality of memory access cycles to time-division multiple access of the system memory for a first processor of the plurality of processors such that memory access is guaranteed for the first processor during the first division of each of the plurality of memory access cycles; and
an act of allotting a second division of each of the plurality of memory access cycles to time-division multiple access of the system memory for a second processor of the plurality of processors such that memory access is conditionally granted to the second processor during the second division of each of the plurality of memory access cycles subject to a determination that at least one of the one or more other memory consumers has not also requested access to the system memory.

21. A system in accordance with claim 20, wherein the memory controller is further configured to perform the following:
an act of receiving a request to access the system memory from the second processor during the second division of the first memory access cycle of the plurality of memory access cycles;
an act of determining that at least one of the one or more other memory consumers has not also requested access to the system memory during the second division of the first memory access cycle; and
in response to the act of determining that at least one of the one or more other memory consumers has not also requested to access the system memory and the act of receiving the request from the second processor, an act of imposing the request from the second processor on the system memory.

22. A system in accordance with claim 21, wherein the memory controller is further configured to perform the following:
an act of determining that the at least one of the one or more other memory consumers has requested access to the system memory during the second division of a second memory access cycle of the plurality of memory access cycles; and
an act of allowing the at least one of the one or more other memory consumers to have access to the system memory during the second division of the second memory access cycle.

23. A system in accordance with claim 20, wherein the memory controller is further configured to perform the following:
an act of allotting a third division of each of a plurality of memory access cycles to time-division multiple access of the system memory for a third processor of the plurality of processors such that memory access is guaranteed for the third processor during the third division of each of the plurality of memory access cycles.

24. A system in accordance with claim 23, wherein the memory controller is further configured to perform the following:
an act of allotting a fourth division of each of the plurality of memory access cycles to time-division multiple access of the system memory for a fourth processor of the plurality of processors such that memory access is conditionally granted to the fourth processor during the fourth division of each of the plurality of memory access cycles subject to a determination that at least one of the one or more other memory consumers has not also requested access to the system memory.

25. A system in accordance with claim 20, wherein the memory controller is further configured to perform the following:
an act of allotting a third division of each of the plurality of memory access cycles to time-division multiple access of the system memory for a third processor of the plurality of processors such that memory access is conditionally granted to the third processor during the third division of each of the plurality of memory access cycles subject to a determination that at least one of the one or more other memory consumers has not also requested access to the system memory.

26. A system in accordance with claim 20, wherein at least one of the one or more other memory consumers includes a serial interface.

27. A system in accordance with claim 20, wherein the one or more memory consumers comprise a plurality of memory consumers.

28. A memory controller configured to perform the following when operated in a system that includes a system memory for which the memory controller governs access, and a plurality of processors and one or more other memory consumers that each access the system memory through the memory controller:
an act of allotting a first division of each of a plurality of memory access cycles to time-division multiple access of the system memory for a first processor of the plurality of processors such that memory access is guaranteed for the first processor during the first division of each of the plurality of memory access cycles; and
an act of allotting a second division of each of the plurality of memory access cycles to time-division multiple access of the system memory for a second processor of the plurality of processors such that memory access is conditionally granted to the second processor during the second division of each of the plurality of memory access cycles subject to a determination that at least one of the one or more other memory consumers has not also requested access to the system memory.

29. A memory controller in accordance with claim 28, further configured to perform the following:
an act of receiving a request to access the system memory from the second processor during the second division of the first memory access cycle of the plurality of memory access cycles;
an act of determining that at least one of the one or more other memory consumers has not also requested access to the system memory during the second division of the first memory access cycle; and
in response to the act of determining that at least one of the one or more other memory consumers has not also requested to access the system memory and the act of receiving the request from the second processor, an act of imposing the request from the second processor on the system memory.

30. A memory controller in accordance with claim 29, further configured to perform the following:
an act of determining that the at least one of the one or more other memory consumers has requested access to the system memory during the second division of a second memory access cycle of the plurality of memory access cycles; and
an act of allowing the at least one of the one or more other memory consumers to have access to the system memory during the second division of the second memory access cycle.

31. A memory controller in accordance with claim 28, further configured to perform the following:
an act of allotting a third division of each of a plurality of memory access cycles to time-division multiple access of the system memory for a third processor of the plurality of processors such that memory access is guaranteed for the third processor during the third division of each of the plurality of memory access cycles.

32. A memory controller in accordance with claim 31, further configured to perform the following:
an act of allotting a fourth division of each of the plurality of memory access cycles to time-division multiple access of the system memory for a fourth processor of the plurality of processors such that memory access is conditionally granted to the fourth processor during the fourth division of each of the plurality of memory access cycles subject to a determination that at least one of the one or more other memory consumers has not also requested access to the system memory.

33. A memory controller in accordance with claim 28, further configured to perform the following:
an act of allotting a third division of each of the plurality of memory access cycles to time-division multiple access of the system memory for a third processor of the plurality of processors such that memory access is conditionally granted to the third processor during the third division of each of the plurality of memory access cycles subject to a determination that at least one of the one or more other memory consumers has not also requested access to the system memory.

34. A memory controller in accordance with claim 28, wherein the memory controller is implemented in a laser transmitter/receiver.

35. A memory controller in accordance with claim 34, wherein the laser transmitter/receiver is a 1 G laser transceiver.

36. A memory controller in accordance with claim 34, wherein the laser transmitter/receiver is a 2 G laser transceiver.

37. A memory controller in accordance with claim 34, wherein the laser transmitter/receiver is a 4 G laser transceiver.

38. A memory controller in accordance with claim 34, wherein the laser transmitter/receiver is a 10 G laser transceiver.

39. A memory controller in accordance with claim 34, wherein the laser transmitter/receiver is a laser transceiver suitable for fiber channels greater than 10 G.

40. A memory controller in accordance with claim 34, wherein the laser transmitter/receiver is an XFP laser transceiver.

41. A memory controller in accordance with claim 34, wherein the laser transmitter/receiver is an SFP laser transceiver.

42. A memory controller in accordance with claim 34, wherein the laser transmitter/receiver is a SFF laser transceiver.
